(19) United States
(12) Patent Application Publication
(10) Pub. No.: US 2006/0169387 A1
(43) Pub. Date: Aug. 3, 2006

(54) Elastic laminate material, and method of making

(76) Inventors: Satinder K. Nayar, Woodbury, MN (US); Donald L. Pochardt, Hastings, MN (US); Sharon K. Nielsen, Woodbury, MN (US)

Correspondence Address: 3M INNOVATIVE PROPERTIES COMPANY, PO BOX 33427, ST. PAUL, MN, 55133-3427, US

(21) Appl. No.: 11/322,385

(22) Filed: Dec. 30, 2005

Related U.S. Application Data
(60) Provisional application No. 60/640,977, filed on Jan. 3, 2005.

(51) Int. Cl. B32B 37/00; B32B 5/26; B32B 27/12

(52) U.S. Cl. 156/73.1; 156/73.4; 442/381; 442/394

(57) ABSTRACT

An ultrasonic welding apparatus, such as a rotary welding apparatus, and methods of using the same for making a laminate material are disclosed. The multi-layered laminate material has a nonwoven material ultrasonically welded to a base layer, which can include elastic.

### CROSS REFERENCE TO RELATED APPLICATIONS

Priority under 35 U.S.C. § 119(e) is claimed to provisional application Ser. No. 60/640,977, filed on Jan. 3, 2005, and entitled “METHOD OF MAKING AN ELASTIC LAMINATE MATERIAL”. The complete disclosure of application 60/640,977 is incorporated by reference herein.

### FIELD OF THE INVENTION

The present invention relates to an elastic laminate material and methods of making the material using an ultrasonic welding system, and more particularly to the method for making the elastic laminate material using a rotary ultrasonic welding system.

### BACKGROUND

In ultrasonic welding (sometimes referred to as “acoustic welding” or “sonic welding”), two parts to be joined (typically parts including some thermoplastic material) are placed proximate a tool called an ultrasonic “horn” for delivering vibratory energy. These parts (or “materials”) are constrained between the horn and an anvil. In many instances, the horn is positioned vertically above the materials and the anvil. The horn vibrates, typically at 20,000 Hz to 40,000 Hz, transferring energy, typically in the form of frictional heat, under pressure, to the materials. Due to the frictional heat and pressure, a portion of at least one of the materials softens or is melted, thus joining the materials.

An ultrasonic type vibratory welding system, in its basic form, has an electrical generating mechanism and an electrical ultrasonic converter for converting electrical energy into vibratory energy. Also included is the horn for delivering the vibratory energy into the weld zone, and an assembly for applying a static force to the materials so as to hold the material in forced contact with the horn. The energy is imparted from the tool to the materials at a selected wavelength, frequency, and amplitude. The ultrasonic horn is an acoustical tool, made of, for example, steel, aluminum or titanium, that transfers the mechanical vibratory energy to the material(s).

One type of ultrasonic welding is known as “continuous ultrasonic welding”. This type of ultrasonic welding is typically used for sealing fabrics and films, or other “web” materials, which can be fed through the welding apparatus in a generally continuous manner. In continuous welding, the ultrasonic horn is typically stationary and the material to be welded is moved beneath it. One type of continuous ultrasonic welding uses a rotationally fixed bar horn and a rotating anvil surface. During welding, the material is pulled between the bar horn and the rotating anvil. The horn typically extends longitudinally towards the material and the vibrations travel axially along the horn into the material.

In another type of continuous ultrasonic welding, the horn is a rotary type, which is cylindrical and rotates about a longitudinal axis. The input vibration is in the axial direction of the horn and the output vibration is in the radial direction of the horn. The horn is placed close to an anvil, which typically is also able to rotate so that the material to be welded passes between the cylindrical surfaces at a linear velocity, which substantially equals the tangential velocity of the cylindrical surfaces. This type of ultrasonic welding system is described in U.S. Pat. No. 5,976,316, incorporated by reference in its entirety herein.

The juxtaposition of the anvil to the horn allows a static force to be provided to the material, allowing the transmission of the ultrasonic energy to the material. This static force is typically maintained by providing a pinching force to the material from a force application system (e.g., a fluid hydraulic system), which forces the horn towards the anvil. The problem with this method of securing the material is that when the material being welded is extremely thin, or contains holes, the horn and the anvil could physically contact each other. When the horn contacts the anvil, a large spike in energy consumption, similar to an electrical short circuit, occurs through the system. As throughput speeds of the material are increased, the level of energy introduced through the horn is also increased, causing the frequency of the surges of energy, which occurs during contact of the horn and anvil, to exponentially increase. These high spikes of energy force the machine into an overload condition causing it to shut down as well as potentially cause holes or brittle spots to be generated in the product. In short, the process becomes inefficient and causes product damage and potential equipment damage when the horn and anvil contacted one another. In a force mode, the welder has to vary the force as the weld area changes to achieve a uniform weld. Also, this change in force due to change in area has to be done rather quickly at high speeds, which can lead to force spikes when a change in force is amended. Such spikes can result in overwelding or underwelding of the part.

One way to remedy this problem, ultrasonic welding systems were developed which maintain a predetermined gap between the anvil and the horn. This gap is typically narrower than the thickness of the material. The necessity to provide a pinching (or holding) force on the product, while maintaining a separation between the horn and the anvil, requires a large and stiff support structure for both the horn and anvil. The support structure is rigid, to maintain the angular position of both the horn and the anvil with respect to each other. Misaligning the surfaces of the horn and anvil causes poor welding and loss of product. Similarly, attempting to adjust the distance of the gap in this type of system allows an unacceptable level of movement to be introduced into the system, once again causing misadjustment of the surfaces of the horn and anvil.

Although ultrasonic welding systems are used for numerous applications, there is always room for improvements, both in the ultrasonic welding system and in products made by those systems.

### SUMMARY OF THE INVENTION

The present invention provides a multi-layered product that is produced using an ultrasonic welding apparatus to seal various layers together. The product includes a first material that is sealed to a second material layer, the seal having been formed by ultrasonic welding.

In one particular aspect, the disclosure is directed to a method of welding a nonwoven layer to a base layer, and the product made by the method. The method includes providing an ultrasonic system, such as a rotary ultrasonic system, comprising an anvil and a horn stack comprising a horn, the anvil and horn having a gap therebetween, placing the nonwoven layer and the base layer together within the gap between the anvil and the horn, rotating at least one of the horn and the anvil while vibrating the horn with ultrasonic energy to obtain a frequency, contacting the nonwoven layer and the base layer with the horn and the anvil, monitoring at least one of the frequency and a temperature of at least one of the horn or the anvil and while maintaining the gap between the anvil and the horn based on either the temperature or a change in the frequency, welding the nonwoven layer to the base layer.

Either the horn or the anvil may contact the nonwoven layer, and similarly, the other of the horn or the anvil may contact the base layer. In one embodiment, the nonwoven layer is contacted by the horn and the base layer is contacted by the anvil.

The ultrasonic welding system suitable for forming the multi-layered product can have various welding apparatus configurations for improving the control of the gap (i.e., distance) between the anvil and the horn. The improved gap control can be used in conjunction with continuous ultrasonic welding or with rotary type ultrasonic welding having one or both of the anvil and the horn rotate. The improved gap control is due, at least in part, to the rigidity of the welding system. The system is generally sufficiently rigid to lock or otherwise maintain the gap, without deforming, for essentially all forces that might result during the welding process. For example, the system is sufficiently rigid that a wrinkle or other thickness change in the material being welded does not deflect the apparatus and affect the gap. Various different modes for controlling and adjusting the distance between the anvil and the horn are disclosed.

An apparatus having reduced degrees-of-freedom available, to better control the gap between the anvil and the horn, is suitable for forming the multi-layered product. The apparatus generally includes a mounting system configured such that the anvil or the horn has only two additional degrees of freedom, in additional to longitudinal rotation about an axis, with the first additional degree of freedom being translational motion in a direction perpendicular to the longitudinal axis, and the second additional degree of freedom being rotational motion about a second axis that is both perpendicular to the longitudinal axis and the direction of the first additional degree of freedom.

Another welding apparatus suitable for forming the multi-layered product is based on using frequency feedback or temperature feedback to adjust the gap between the anvil and the horn. The apparatus generally includes a frequency sensor adapted to provide a signal based on the frequency of the hom or a temperature sensor adapted to measure the temperature of the horn and/or the anvil, and a positioning system for adjusting the gap between the horn and the anvil in a predetermined way based on the signal. The frequency sensor can be selected to determine the frequency by, for example, the voltage delivered by the source of ultrasonic energy, the current drawn by the source of ultrasonic energy, the voltage induced in an inductive sensor positioned near the horn, the change in capacitance of a capacitance sensor positioned near the horn, an optical sensor positioned to observe the horn, and a contact sensor in physical contact with the horn. The temperature sensor can be selected to determine the temperature, for example, on the surface or at an internal location of the horn or the anvil, or the temperature sensor can be an optical sensor or other non-contact sensor. In some embodiments, a cooling device may be added to facilitate controlling the temperature of the horn, anvil, or both.

Another welding apparatus suitable for forming the multi-layered product is generally configured to control the distance between the anvil and the horn by utilizing a deformable stop assembly, so as to be able to apply force to press the horn against the fixed stop such that elastic deformation of the fixed stop provides fine control over the gap between the horn and the anvil.

The use of frequency feedback, temperature feedback or a deformable stop assembly can be used with a rotary anvil, stationary anvil, rotary horn, stationary horn, or any combination thereof, all of which are suitable for forming the multi-layered product. The system can be configured to adjust the distance between the anvil and the horn, or to adjust the force applied to one of the anvil and the horn (usually the horn) to bring the two to the desired distance with the multi-layered product therebetween. The system could also modify weld amplitude or a cooling or heating rate of the horn and/or anvil to control the gap.

These and various other features which characterize the products of this disclosure and methods for making those products are pointed out with particularity in the attached claims. Products can be made by the methods with reduced complications and with significantly increased line speeds, as compared to conventional methods. For a better understanding of the multi-layered products of the disclosure, their advantages, their use and objectives obtained by their use, reference should be made to the drawings and to the accompanying description, in which there is illustrated and described preferred embodiments of the invention of this disclosure.

### BRIEF DESCRIPTION OF THE DRAWING

In the several figures of the attached drawing, like parts bear like reference numerals, and:

FIG. 1 is a cross-sectional view of a product made by the process according to the present invention;

FIG. 2 is a schematic diagram of the process of the present invention, illustrating the various materials forming the inventive products;

FIG. 3 is a partially detailed, schematic diagram of a horn and anvil configuration with multi-layered material therebetween;

FIG. 4 is a schematic diagram of a rotary horn and anvil configuration, for producing two portions of product of the present invention;

FIG. 4A is a first possible configuration for an anvil surface;

FIG. 4B is a second possible configuration for an anvil surface;

FIG. 5 is a front and right side perspective view of an exemplary rotary welding apparatus according to the present invention, the apparatus having multiple sub-assemblies;

FIG. 5A is a front and right side perspective view of an alternate exemplary rotary welding apparatus according to the present invention, similar to that of FIG. 5;

FIG. 6 is a front plan view of an anvil roll sub-assembly of the apparatus of FIG. 5;

FIG. 7 is an enlarged front plan view anvil roll sub-assembly, from the same perspective as FIG. 6;

FIG. 8 is a cross-sectional view of the anvil roll sub-assembly taken along line 8-8 of FIG. 7;

FIG. 9 is a perspective view of a horn mount sub-assembly of the apparatus of FIG. 5;

FIG. 10 is a front plan view of a horn assembly, which is held by horn mount sub-assembly of FIG. 9;

FIG. 11 is a cross-sectional view of the horn assembly taken along line 11-11 of FIG. 10;

FIG. 12 is a perspective view of a horn-anvil gap adjustment sub-assembly of the apparatus of FIG. 5;

FIG. 13 is a front plan view of a horn lift sub-assembly of the apparatus of FIG. 5;

FIG. 14 is a front plan view of the horn lift sub-assembly of FIG. 13;

FIG. 15 is a cross-sectional view of the horn lift sub-assembly taken along line 15-15 of FIG. 14;

FIG. 15A is an alternate embodiment of a horn lift sub-assembly, similar to the view of FIG. 15;

FIG. 15B is another alternate embodiment of a horn lift sub-assembly, similar to the view of FIG. 15;

FIG. 16 is a front plan view of a nip sub-assembly of the apparatus of FIG. 5;

FIG. 17 is a schematic side view of a fixed gap system, the horn in a first position; and

FIG. 18 is a schematic side view of the fixed gap system of FIG. 17, the horn in a second position.

### DETAILED DESCRIPTION

As provided above, the present invention is directed to multi-layered laminated products made by improved ultrasonic welding methods. The products can be made by scan-type continuous ultrasonic welding or with rotary-type continuous ultrasonic welding having one or both of the anvil and the horn rotate. These welding methods can incorporate various configurations for better measuring, sensing, and controlling the gap and the movement between the horn and the anvil.

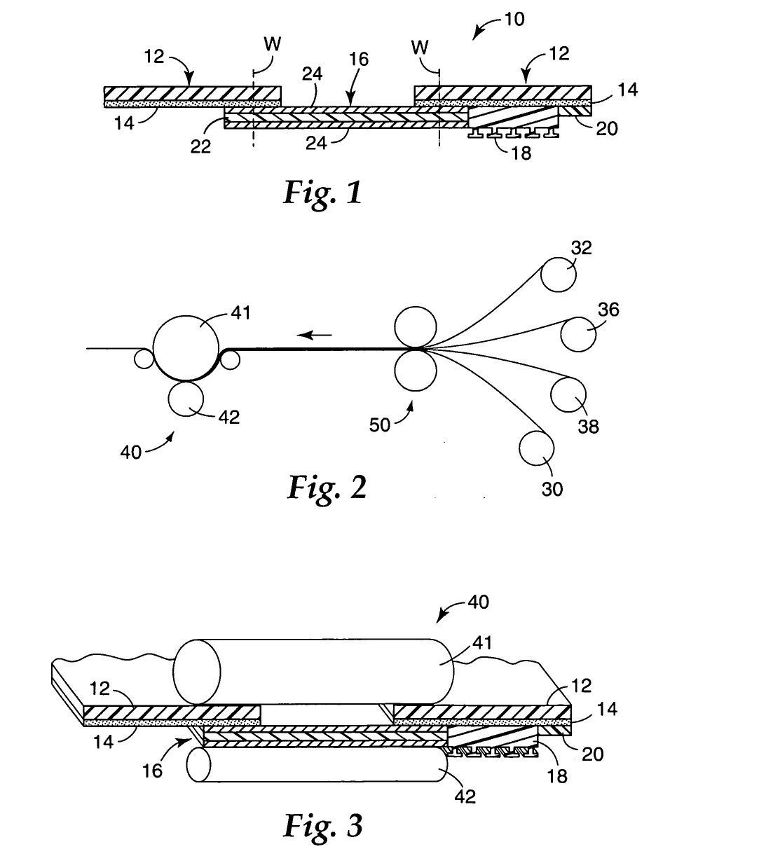

An example of a product according to the present invention is illustrated in FIG. 1. This product 10 is a thin, multi-layered composite material made by ultrasonic welding, in accordance with the present invention. Broadly, a first material is adhered to a second material by a weld formed by ultrasonic welding and facilitated by adhesive. Specifically, composite material 10 includes a nonwoven tape 12 welded to a base layer 16. In the embodiment illustrated, composite material 10 includes two pieces of nonwoven tape 12, both being welded to base layer 16. Composite material 10 also includes a mechanical attachment portion 18 and a tab 20, which may be referred to as a “finger lift tab”. Tab 20 facilitates grasping an end of composite material 10.

In this embodiment, nonwoven tape 12 includes an adhesive layer 14 on one side. Adhesive layer 14 facilitates handling of nonwoven tape 12 prior to being welded to base layer 16; that is, adhesive layer 14 tacks nonwoven tape 12 to base layer 16. After welding, adhesive layer 14 may no longer be present between nonwoven tape 12 and base layer 16 in the area where the weld is.

Regions indicated as “W” in FIG. 1 approximate the position of the ultrasonic welds. In this example, nonwoven tape 12 having adhesive layer 14 is welded to base layer 16. Mechanical attachment portion 18 and tab 20 are attached to nonwoven tape 12 by adhesive layer 14.

In one particular embodiment, base layer 16 comprises a multilayered elastic material, composed of elastic film 22 with nonwoven surface layer 24 on each side of film 22. Composite material 10 having an elastic base layer 16 is suitable for use, for example, as a disposable diaper attachment mechanism, also referred to as diaper tape. In another particular embodiment, base layer 16 comprises a non-woven material.

In a particular example of composite material 10, a suitable elastic base layer 16 is a three-layer laminate having a layer of polypropylene spun-bond (34 g/m²), a layer of block copolymer elastic/polypropylene blend (70 g/m²), and a layer of high elongation carded polypropylene (27 g/m²). An example of a suitable nonwoven tape 12 is nonwoven spun-bond polypropylene (42 g/m²) coated with polypropylene (20 g/m²). Present on one side of nonwoven tape 12 is a layer, at 33 g/m², of pressure sensitive adhesive.

In another particular example, base layer 16 is a three-layer laminate with a film 22 sandwiched between nonwoven layers 24. Film 22 is a three layer laminate film (4.5 mil thick) having a block copolymer elastic/polypropylene blend core. The nonwoven layers 24 are polypropylene spun-bond (approx. 80 g/m²).

In another suitable embodiment of a composite material 10, made by the ultrasonic welding methods described herein, has base layer 16 being a nonwoven material.

Examples of suitable nonwoven materials, for any or all of nonwoven tape 12, nonwoven surface layer 24 and base layer 16, include fibrous materials which are formed of fibers without aid of a textile weaving or knitting process, which includes materials such as spunbonded, melt blown, spun laced or carded materials. The materials may be polymeric, such as a polyolefin, for example polyethylenes and/or polypropylenes, or a polyurethane, or a natural material, such as cotton or wool, or any combinations thereof. In many structures, it is preferred that at least one of the nonwoven materials comprises a thermoplastic polymeric material.

As used herein, the terms “elastic”, “elastomeric”, and variations thereof, refer to any material which can be elongated or stretched in a specified direction from about 20 percent to at least about 400 percent by application of a biasing force and which recovers to within about 35 percent of its original length after being subsequently released from the biasing force after a short-term duration of the stretched condition. Examples of suitable elastic materials, such as for base layer 16, include films, foams or layers of natural rubber, synthetic rubber or thermoplastic elastomeric polymers.

In some embodiments, such as for base layer 16 having elastic film 22 with nonwoven surface layer 24 on each side of film 22, the layer may be composed of multiple materials, and may be a stretch-bonded-laminate (SBL) material or a neck-bonded laminate (NBL) material, or like resiliently stretchable materials as are well known to those skilled in the art.

Any or all of the component layers of composite material 10 typically have thicknesses of about 0.01 mm to about 0.5 cm at the bonding regions “W”, although thicker and thinner layers are also feasible.

Referring to FIG. 2, a schematic diagram of the ultrasonic welding process and various layers and materials used to make multi-layered composite material 10 of FIG. 1 is illustrated. Extended length of material, retained on spools or cores, is provided. For composite material 10 as described above, a length of nonwoven 12 (having adhesive layer 14 thereon) is provided from spool 32, a length of base layer 16 is provided from spool 36, a length of mechanical attachment portion 18 is provided from spool 38, and a length of material for tab 20 is provided from spool 30.

Referring to FIG. 1 again, it is illustrated that multi-layer composite material 10 includes two layers of nonwoven tape 12 with adhesive layer 14. It is understood that, nonwoven tape 12 may be slit or otherwise cut to provide two separate pieces of material after leaving spool 32, or, two spools 32 may be provided. If provided from one spool 32, nonwoven tape 12 is split prior to being combined with the other layers.

Returning to FIG. 2, material from spools 32, 36, 38, 30 progresses to a tender and laminating station 50, where nonwoven tape 12 with adhesive layer 14, base layer 16, mechanical attachment portion 18 and tab material 20 are arranged in the desired configuration. Typically, no additional adhesive or other mechanism (e.g., heat) is used to laminate nonwoven 12 to base layer 16, as adhesive layer 14 on nonwoven 12 is sufficient to retain the construction together until the ultrasonic welding process. In the embodiment of FIG. 1, adhesive layer 14 also holds mechanical attachment portion 18 and tab material 20. Methods for laminating multiple layers together are well known. It is understood by those in the field of laminating that process conditions such as tension, speed, pressure, and the like, will affect the lamination process.

After laminating the various materials to form the desired configuration, the multi-layered laminate progresses to an ultrasonic welding station 40, which includes an anvil 41 and a horn 42. The multi-layered laminate is positioned between anvil 41 and horn 42, and welded seals are made.

FIG. 3 illustrates nonwoven 12, base layer 16, mechanical attachment portion 18 and tab material 20 arranged in the desired configuration between anvil 41 and horn 42. Although the detailed means of ultrasonic welding are provided below, at least one of anvil 41 and horn 42 is oscillated at ultrasonic frequencies, to obtain sufficient heat that the materials present between anvil 41 and horn 42, in the designated region, are welded together. The welding can be done using either a rotary horn or a scan (bar) horn. A patterned anvil and/or a patterned horn could additionally be used. All of these various processes for ultrasonic welding are described below. Rotary ultrasonic welding is preferred over stationary or bar ultrasonic welding, at least because rotary welding can be done at a faster rate with less opportunity to rip or tear the material(s) being welded.

The bonding that results from ultrasonic welding can result from partial or complete melting of one or more materials, such as thermoplastic material, in one or both of the materials being welded. Bonding can result from partial or complete melting of material of only one of the layers being acted upon, with the melted material interacting with the corresponding adjacent layer which in turn results in mechanical interlocking of the layers to each other. The welded bond is stronger compared to an adhesive attachment between the various materials, and has less creep and a higher shear strain associated with it.

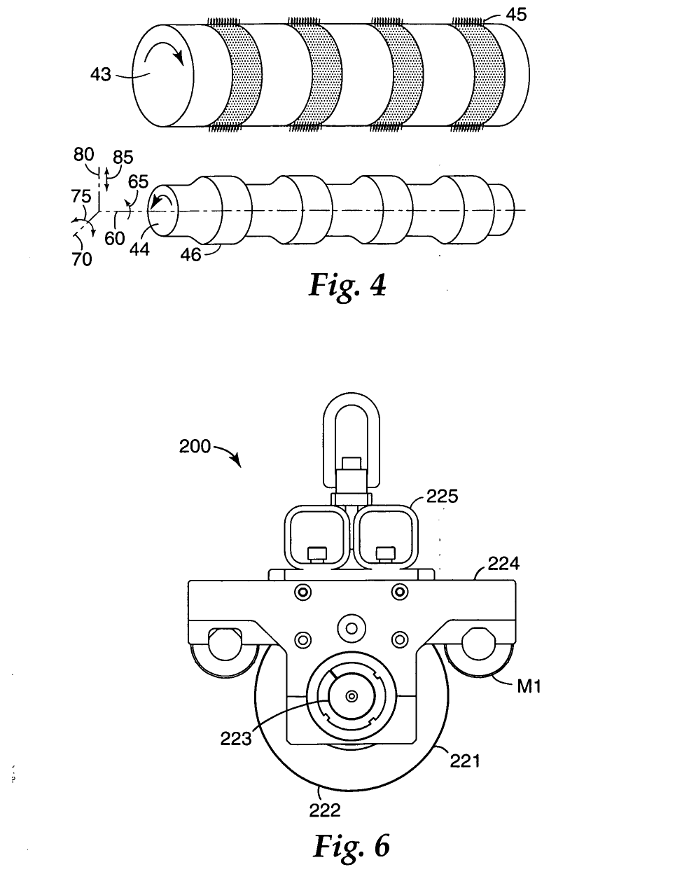

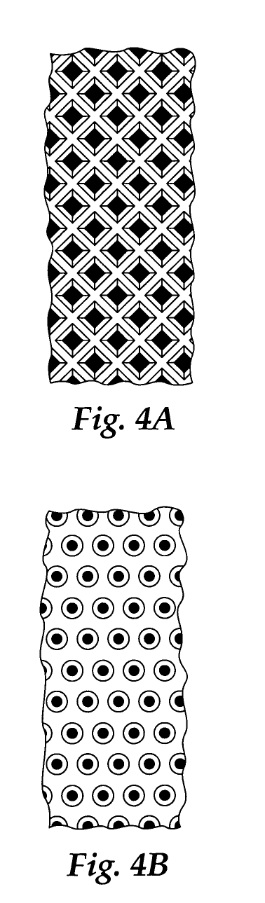

In the particular generic embodiment illustrated in FIG. 4, anvil 41 is a patterned rotary anvil 43 and horn 42 is a rotary horn 44 having a smooth surface 46 in the region where the welding occurs. In the illustrated embodiment, anvil 43 and horn 44 are configured to produce four welds simultaneously. Thus, two multi-layered composite products 10 of FIG. 1 can be made simultaneously.

Anvil 43 can include a raised, patterned surface 45 in the regions where welding is desired; alternately, a raised, patterned surface 45 could be present on the entire anvil surface. Generally, a patterned surface provides 5-30% area for welding. An example of a patterned surface is a diamond pattern, such as illustrated in FIG. 4A, with diamonds having sides of approximately 5-30 mils (130 to 760 micrometers; 0.13-0.76 mm) and approximately 10-30% of the area is covered with diamonds. Another example of a patterned surface is a circular dot pattern, such as illustrated in FIG. 4B, with dots approximately 2-20 mils (50 to 500 micrometers; 0.05-0.5 mm) in diameter and approximately 5-20% of the area covered with dots. It is understood that other patterns, and also surfaces without discernible patterns, can be used.

During the welding process, generally horn 42 oscillates, at a frequency and amplitude, generally in the direction indicated by arrow 85. Frequencies of about 15-70 KHz are suitable, although higher and lower frequencies may alternately be used. The amplitude is a function of the voltage applied to the oscillating piece. For most processes for making product 10, e.g., with frequencies of 15-70 KHz, a static gap between anvil 41 and horn 42 of about 1.5 mil (about 37 micrometer) to about 3.5 mil (about 87 micrometers) is suitable. For 20 KHz, as an example, peak-to-peak amplitudes of about 1 mil (about 25 micrometers) to about 2.5 mil (about 62 micrometers) are suitable. It is understood that larger and smaller gaps could be used, depending on the materials being welded, and that different frequencies and amplitudes could also be used. For example, thicker materials can use a larger gap and larger amplitude.

Ultrasonic Welding

As discussed above, the multi-layered laminate composite product is produced by ultrasonically welding at least two materials together. For multi-layered laminate composite product 10 of FIG. 1, nonwoven 12 with adhesive layer 14 is welded to base layer 16. Various processes for ultrasonic welding are described below which can be used for welding composite product 10, with process features that can be combined with other embodiments or used alone. For example, an apparatus having reduced degrees of freedom is described using a rotary ultrasonic apparatus, where both the anvil and horn are rotary. The features that provide the reduced degrees of freedom could likewise be incorporated into an apparatus where, for example, the horn is rotary and the anvil is stationary. As another example, a method for monitoring and adjusting the gap between the anvil and horn, using resonant frequency feedback, is described using a stationary apparatus, having both the horn and the anvil stationary. The features that monitor and adjust the gap could likewise be incorporated in a rotary apparatus. As yet another example, a method for fixing the gap between the anvil and horn is described using a stationary apparatus, having both the horn and the anvil stationary. The features that set the gap could likewise be incorporated in a rotary apparatus.

Controlling Gap by Reduced Degrees of Freedom

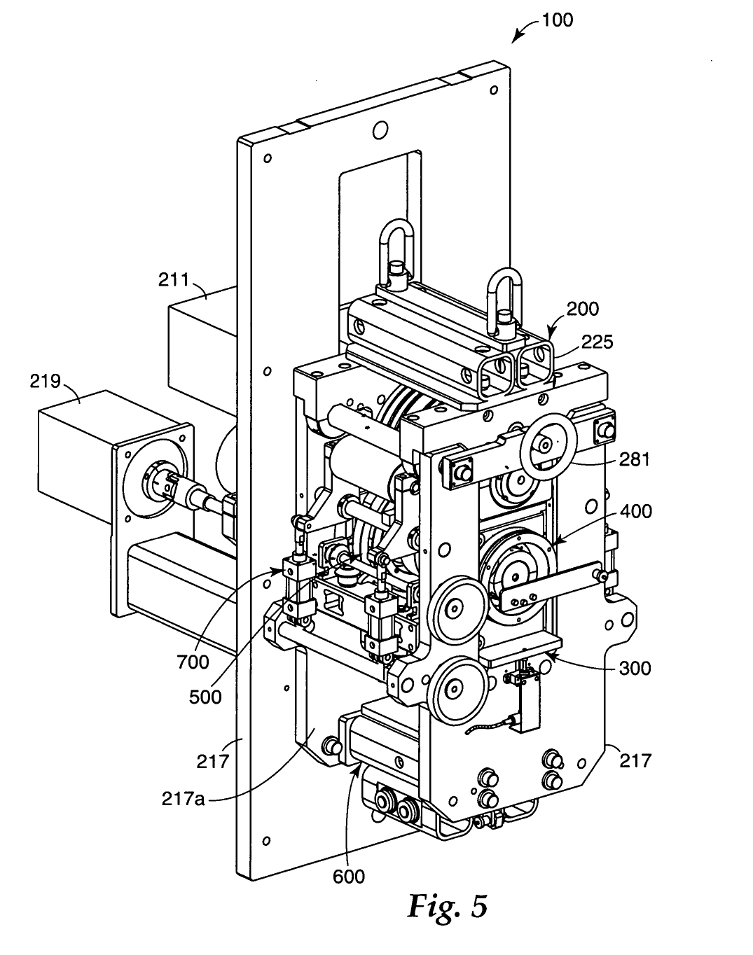

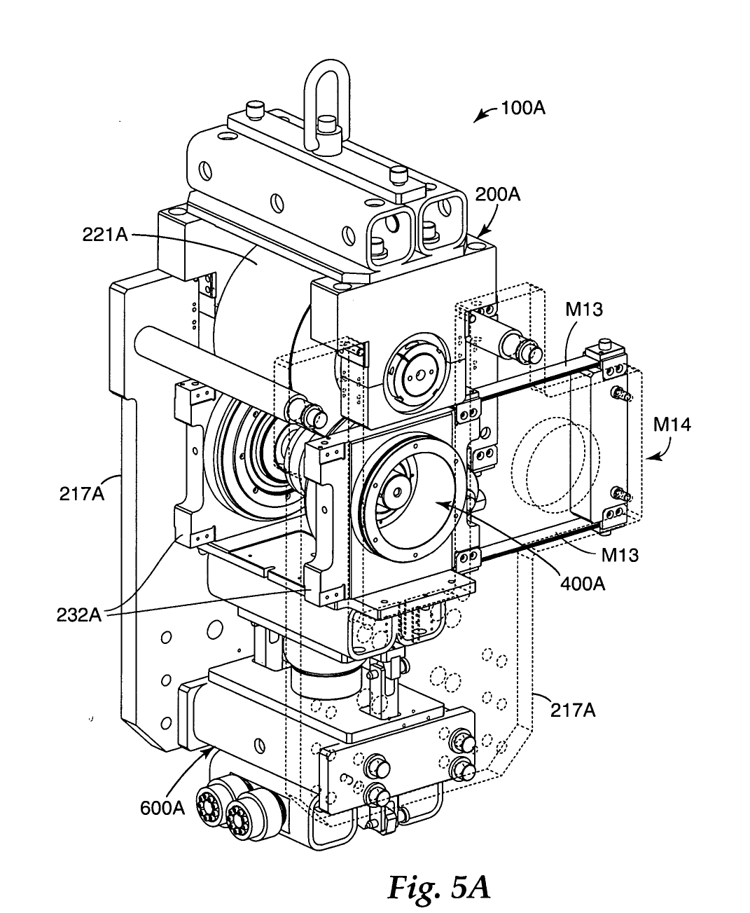

Referring to FIG. 5, a rotary welding system 100 is illustrated. Rotary welding system 100 includes features that limit the degrees-of-freedom of the horn in relation to the anvil, thus better controlling the gap and the movement between the horn and the anvil during the welding process.

System 100 includes an anvil assembly 200, a horn mount assembly 300, a horn assembly 400, a horn-anvil gap adjustment assembly 500, a horn lifting assembly 600, and a nip assembly 700. Additional details regarding each of these assemblies are provided below. Also illustrated in FIG. 5 as a part of rotary welding system 100 are side plates 217, tie rods 218, a horn servomotor 219, and an anvil servomotor and gearbox 211.

FIG. 6 provides a detailed view of anvil assembly 200. Anvil assembly 200 includes an anvil roll 221 having a roll face 222 and journals 223. Anvil roll 221 can be any suitable roll, such as a die roll, embossing roll, printing roll, or welding rolls. Anvil bearing blocks 224 are mounted to anvil frame 225. Anvil roll 221 is configured to rotate around an axis, preferably an axis extending longitudinally through the center of roll 221.

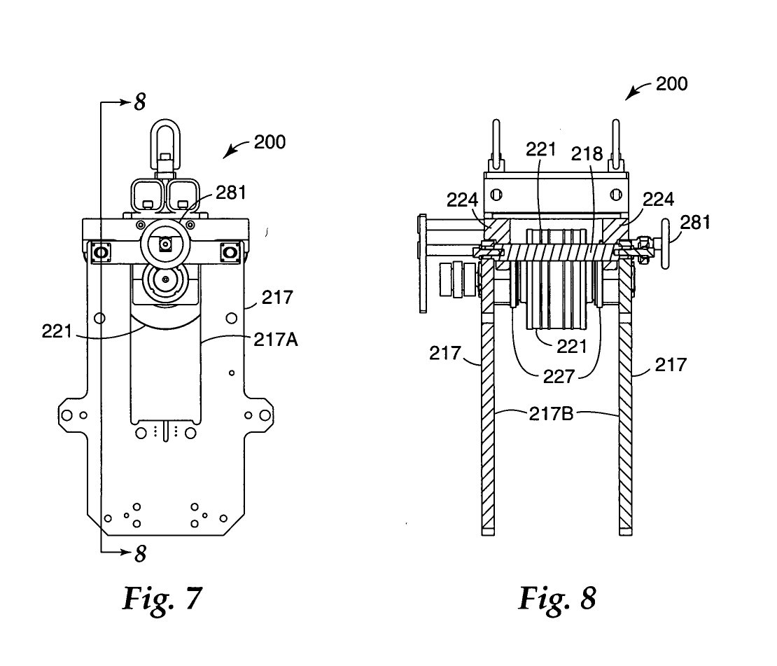

Referring to FIGS. 7 and 8, additional views of anvil roll assembly 200, supported by side plates 217 having inside or bearing surfaces 217b, are illustrated. Anvil roll 221 is mounted on tie rods 218 and to side plates 217, in a manner so that roll 221 can rotate around its longitudinal axis.

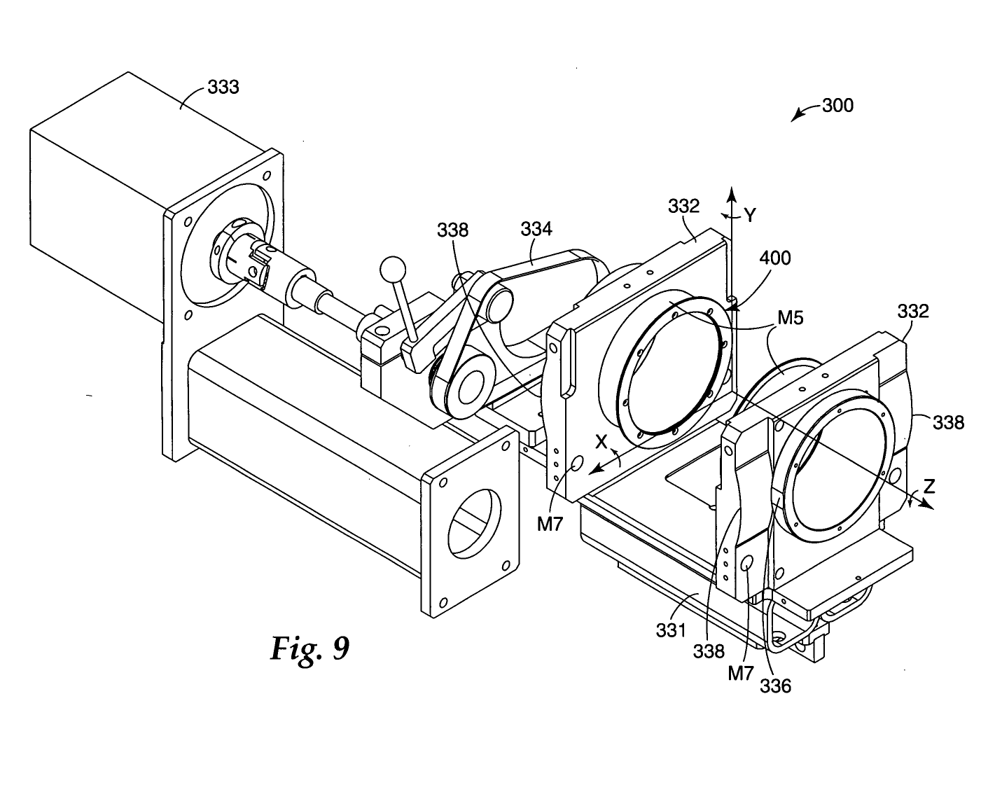

FIG. 9 shows horn mount assembly 300, which includes a mount frame 331, horn-bearing blocks 332, a horn drive motor 333, and a horn drive mechanism, such as belt 334.

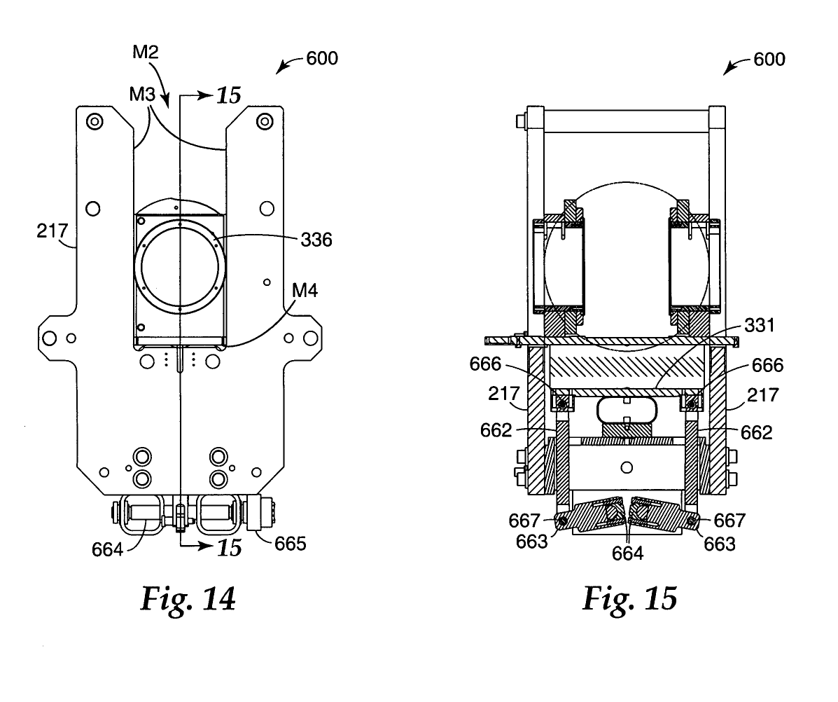

When horn mount assembly 300 is installed in welding system 100, slots M2 (as shown in FIG. 14) in side plates 217 guide and allow horn mount assembly 300 to move. In particular, surfaces 336 on bearing blocks 332 contact surfaces M3 of side plates 217; preferably, at least a portion of bearing block 332 fits within slot M2. In some embodiments, surfaces 336 are cylindrical surfaces, though this is not essential. Surfaces 336 inhibit movement of assembly 300 in two directions, thus removing two degrees of freedom, one linear along the X-axis and one rotational around the Y-axis (see FIG. 9). Another rotational degree-of-freedom around the Z-axis is removed by rest buttons M4 on mount frame 337. Only two additional degrees-of-freedom remain.

FIG. 4, in a more simplified form with anvil 41 and horn 42, illustrates the axis and available degrees of freedom. Horn 42 has first axis 60 extending longitudinally therethrough. Orthogonal to first axis 60 is a second axis 70, which is the direction in which anvil 41 is positioned. A third axis 80 is orthogonal to each of first axis 60 and second axis 70.

In one mode, horn 42 rotates about first axis 60 in the direction indicated by arrow 65. The first additional degree of freedom is translational motion in a direction perpendicular to the first axis 60, which would be in the direction indicated by third axis 80. The first additional degree of freedom is indicated by the arrow 85. The second additional degree of freedom is rotational motion about second axis 70, indicated by arrow 75, that is both perpendicular to first axis 60 and the direction 85 of the first additional degree of freedom.

Bearing blocks 332 also have a second set of surfaces 338, which also in an exemplary embodiment are cylindrical surfaces. The radius of these surfaces 338 is half the distance between the inside or bearing surfaces 217b (FIG. 8) of side plates 217. Surfaces 338 remove a translational degree of freedom along the Z-axis.

It is well recognized that all rigid bodies have six degrees-of-freedom. The features described above remove four degrees-of-freedom. The two remaining available degrees of freedom are translational movement along the Y-axis (towards and away from the anvil) and rotational movement along the X-axis. The combination of these two degrees-of-freedom allow the gap between horn 30 and the anvil to be adjusted independently on both sides of horn 30.

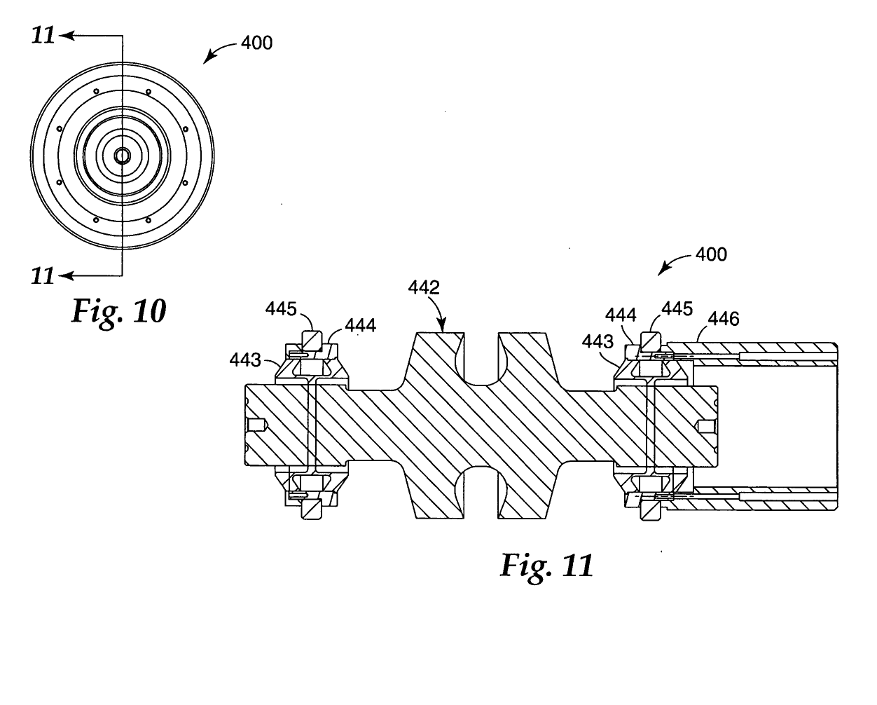

FIGS. 10 and 11 shows horn assembly 400, which includes horn 442, nodal mounts 443, horn bearing rings 444, horn bearings 445, and horn drive sprocket 446.

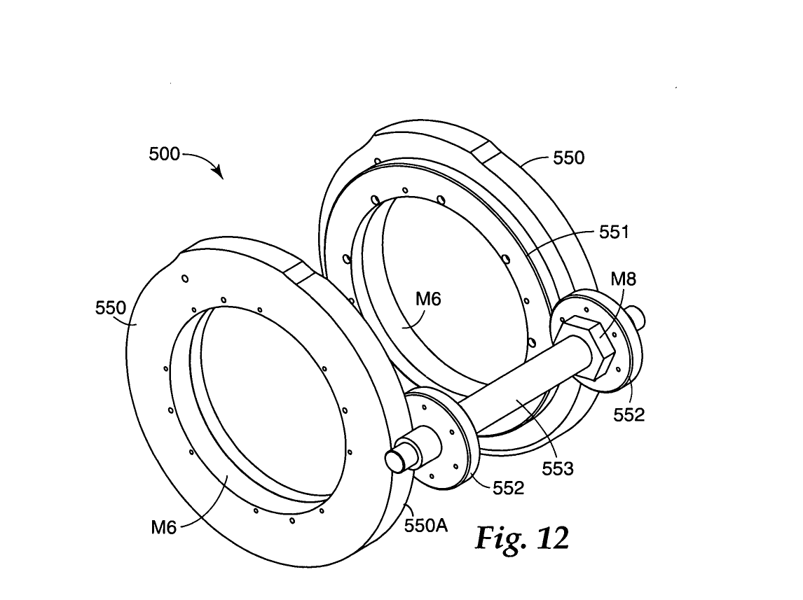

FIG. 12 shows horn gap or horn-anvil gap adjustment assembly 500. Assembly 500 includes first and second cams 550 and a drive gear 551 attached to the cams. The inner cylindrical surface of the cams, M6, rests on the cylindrical surfaces M5 of assembly 300 (FIG. 9). Clearance between surfaces M5 and M6 allows the cams 550 to rotate about the z-axis.

Gear shaft 553 is a non-rotating shaft that is mounted between bearing blocks 332 using holes M7 (FIG. 9). Driving gears 552 are rotatably mounted to gear shaft 553. Driving gears 552 are rotated independently using a wrench on the hex feature M8. Rotation of the driving gears 552 causes the cams 550 to rotate.

In use, the outer cam surface 550a is machined to generate a linear function, h=Aθ, where h is the total rise of the cam, θ is the angle of rotation of the cam, and A is a constant. In a preferred embodiment, cams 550 generate a rise of 0.100 inch (about 2.5 mm) over 300 degrees of cam rotation. This provides an adjustment resolution of 3/10000 inch per degree (about 0.0076 mm per degree).

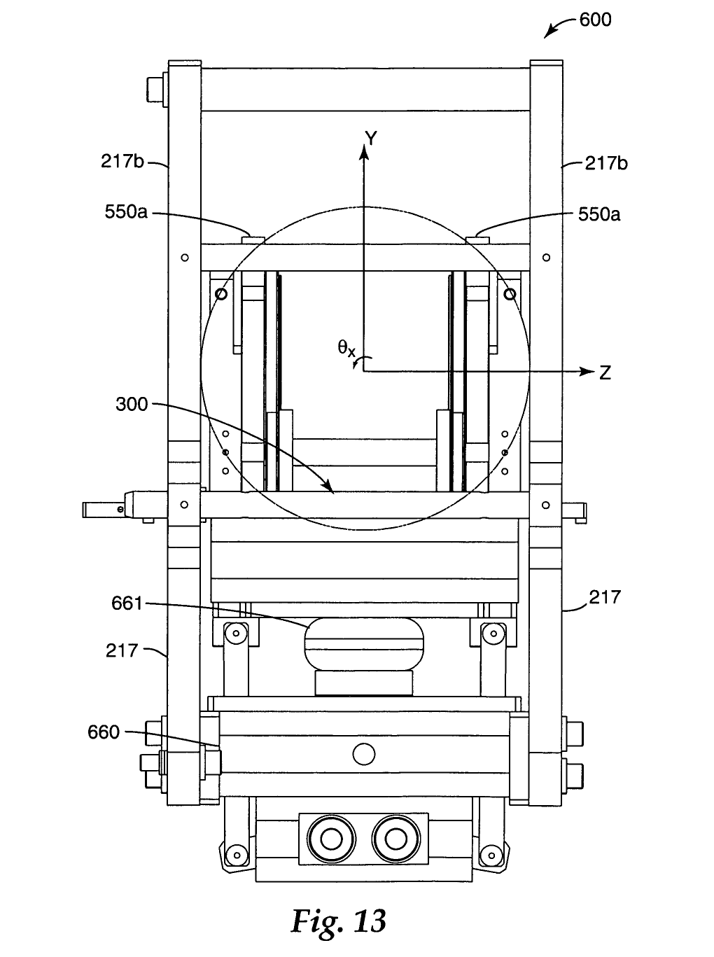

FIG. 13 shows horn lift assembly 600, which is used to move, generally raise and lower, horn mount assembly 300 in relation to side plates 217. The motion of horn mounting assembly 300 is stopped when cam surface 550a contact cam followers 227 of anvil assembly 200.

Horn lift assembly 600 includes lift frame 660 fixedly attached to side plates 217. Attached to lift frame 660 is pneumatic bellows 661, which is configured to expand and decrease, as desired. In use, pressurizing bellows 661 applies force to horn mount assembly 300 to push assembly 300 towards anvil roll 221 (not shown in FIG. 13, but see FIG. 8); other force generators, such as linear actuators, pneumatic cylinders and hydraulic cylinders could alternately be used. As discussed previously, horn mount assembly 300 has two remaining degrees-of-freedom. One is translational along the Y axis and one rotational along the X(θₓ)-axis (FIG. 13).

In some methods, a ‘force mode’ may be used, but is not generally preferred. The ‘force mode’ uses a constant or fixed weld force selected to weld material having target (e.g., average) material properties (e.g., thickness). Force mode is useful to allow the ultrasonic horn to follow any runout of the anvil or rotary horn. If the properties of the weld material differ from the target value (e.g., thickness), the constant force system may, however, produce unacceptable weld quality. The resulting product might be underwelded if a thicker than average or wrinkled product is passed between the anvil and horn, and overwelded if a thinner than average material is used. With a force mode system, an area of thicker web requires more weld energy to provide the weld. The thicker web could deflect the welding system, altering the applied force and thus resulting in a weaker weld. Additionally, if web speed is changed, the force and/or amplitude of the system may need to be changed to hold a constant weld quality. For instance, a weld amplitude or force versus line speed algorithm may need to be developed and followed. A force mode system may be speed sensitive, in that for very high web speeds, the inertia of the system may not allow the horn to follow the runout of the anvil. In such a case, weld variability will increase. Further, if a break in the materials being welded were to occur, metal to metal contact of horn to anvil may occur, which can be damaging to the system.

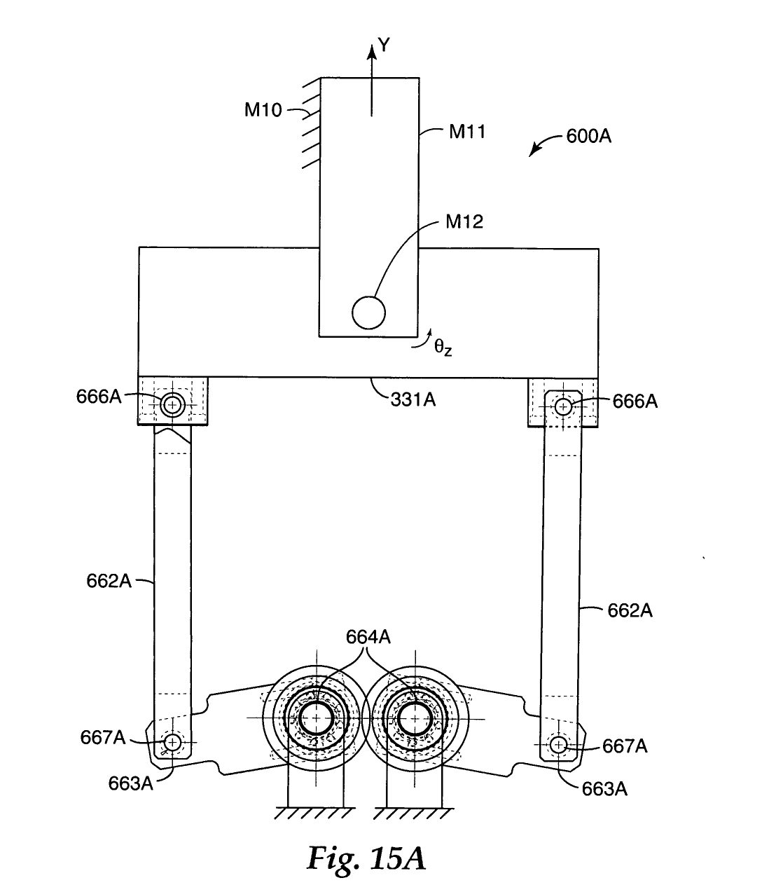

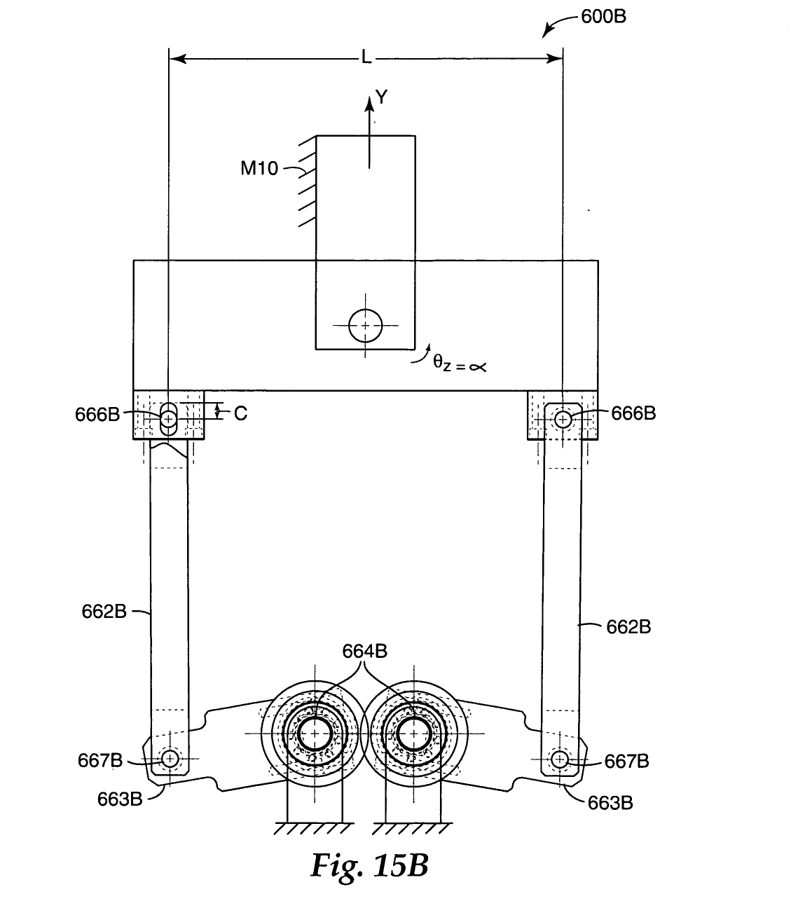

FIGS. 14 and 15 show additional views of horn lift assembly 600. In this embodiment, a geared 7-bar linkage, with pivot slop, is used to control the rotation of horn mount assembly 300 in relation to side plates 217 and mount frame 331. This linkage includes connecting link arms 662, pivot arms 663, pivot shafts 664, gears 665, and pivot connections 666, 667. As bellows 661 lifts horn mount assembly 300, connecting link arms 662 raise the ends of pivot arms 663, which rotate an equal amount, due to arms 663 being geared together. If there were no clearance or slop in the pivot joints 666, 667, horn mount assembly 300 would only move vertically and the rotational degree-of-freedom (Ox) would be removed. However, by the inclusion of clearance to joints 666, 667, an amount of rotation is allowed.

FIGS. 15A and 15B shows the geared 7-bar linkage 600A, along with the horn mount assembly 300 in more basic kinematic form. Referring to FIG. 15A, in this embodiment, link M10 is ground. Linkage 600A includes connecting link arms 662A, pivot arms 663A, pivot shafts 664A, and pivot connects 666A, 667A. Connecting link arms 662A raise the ends of pivot arms 663A at joint 667A, arms 663A which rotate an equal amount, due to arms 663A being geared together.

Pivot arms 663A are two binary links that are connected to ground and to link arms 662A via joints 666A and 667A, respectively. Pivot arms 663A are also connected to each other using a gear joint. The ratio of the gear joint is 1:1. Link arms 662A are also binary links that are connected to pivot arms 663A and to mount frame 331A via revolute joints 667A, 666A respectively. Mount frame 331A is a ternary link that is connected to arms 662A and slider block M11 with pivot joints 667A and M12. Slider block M11 is connected to ground and mount frame 331A using joints M10 and M12. Slider block M11 controls the motion of mount frame 331A so that mount frame 331A has only a translational and rotational degree-of-freedom.

Linkage 600A includes joint clearance at joints 666A by including an oversized hole. Additionally or alternatively, joint clearance could be present at pivot joints 667A. In a conventional geared-7-bar linkage mechanism without joint clearances, the motion of mount frame 331A would only be translational as pivot arms 663A are rotated. By having the joint clearance, the horn 442 of horn mount assembly 300, which is connected to mount frame 331A, can be adjusted with limited angular motion.

The clearance in the joint may also be accomplished using clearance controls/limits angular motion θx, with the use of a slot, as is illustrated in FIG. 15B. In FIG. 15B, linkage 600B includes connecting link arms 662B, pivot arms 663B, pivot shafts 664B, and pivot connections 666B, 667B. Pivot connections 666B include a slot that provides joint clearance. If L is the distance between joints 666B, and C is the joint clearance, then the allowed angle of rotation, α, is given by,

$$α = 2 {Sin}^{- 1} ( \frac{C}{L} )$$

The clearance, either an oversized hole, a slot, or other, is selected so that the rotation allows variations in the gap between horn 442 and anvil to adjust for manufacturing tolerances and process variations. The clearance is not, however, so great as to prevent or inhibit mounting of horn 442 and stopping correctly on cams 550.

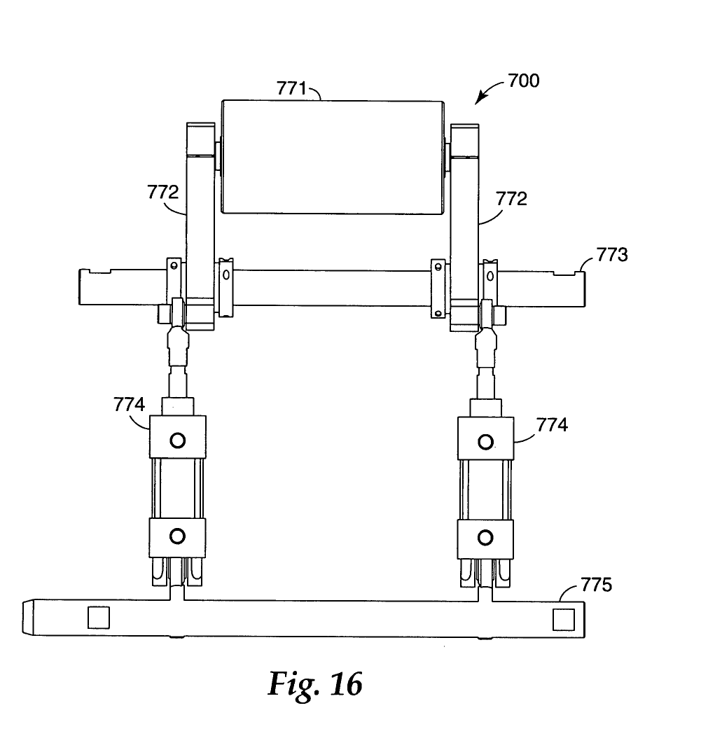

FIG. 16 shows nip assembly 700. Nip assembly includes nip roller 771, nip arms 772, pivot shaft 773, nip cylinders 774, and cylinder support shaft 775.

An alternate exemplary rotary welding module is illustrated in FIG. 5A as apparatus 100A. Similar to apparatus 100 of FIG. 5, apparatus 100A has multiple sub-assemblies. Shown in FIG. 5A are anvil assembly 200A which includes anvil roll 221A, horn assembly 400A, and horn lifting assembly 600A. Also shown in FIG. 5A are side plates 217A. Apparatus 100A includes leaf springs M13, typically at least two pairs of leaf springs M14. Each pair of leaf springs M14 is attached to different bearing blocks 332 and different side plates 217A.

A welding apparatus, based on reducing the degrees-of-freedom available to better control the gap between the anvil and the horn, generally includes anvil roll 221 or other rotatable tool having an first axis, and a mounting system for supporting anvil roll 221 so that it can rotate about its first axis. The mounting system is configured such that anvil roll 221 has only two additional degrees of freedom, the first additional degree of freedom being translational motion in a direction perpendicular to the first axis, and the second additional degree of freedom being rotational motion about a second axis that is both perpendicular to the first axis and the direction of the first additional degree of freedom. This limited range of movement stabilizes the distance between the anvil and the horn. Details regarding controlling the gap between the anvil and horn by reduced degrees of freedom are described in Assignee's co-pending application 60/640,979, entitled “Method of Adjusting the Position of an Ultrasonic Welding Horn” having attorney docket number 59643US002, the entire disclosure of which is incorporated by reference herein.

Summarized, an apparatus to control the gap by reduced degrees of freedom has a rotatable tool, such as an anvil or a horn having a first axis; and a mounting system for supporting the rotatable tool so that it can rotate about its first axis. In such a manner, the rotatable tool has only two additional degrees of freedom, translational motion in a direction perpendicular to the first axis, and rotational motion about a second axis that is both perpendicular to the first axis and the direction of the first additional degree of freedom. A method to make composite material 10 would include providing a mounting system for supporting a rotatable tool so that it can rotate about its first axis and such that the rotatable tool has only two additional degrees of freedom, mounting a rotatable tool having an first axis within the mounting system; and contacting the web with the tool roll so as to treat the web.

Controlling Gap by Frequency or Temperature Feedback

A second general method for better controlling the gap and the movement between the horn and the anvil during the welding process is provided below. In “fixed gap” applications, it is desired to maintain the distance between the horn and anvil very precisely. However, as an ultrasonic horn operates, the temperature of the horn generally increases, resulting in expansion of the material of the horn and thus increasing the horn dimension. In many applications, the expansion of the horn is enough to reduce to gap to a less than the allowable value, or even to allow the horn to contact the anvil directly. This is not desirable. Unknown or uncontrolled horn dimensional changes (e.g., changes in horn diameter or length) can cause difficulties.

It has been determined that the resonant frequency of a horn is a function of the geometry and material properties of the horn. In particular, the resonant frequency is inversely proportional to the dimensions of the horn. That is, the resonant frequency of the horn reduces as the dimensions of the horn increased. The change in horn dimensions can be calculated accurately and with good resolution, based on knowing the instantaneous resonant frequency and the initial resonant frequency, which can be electronically measured.

The dimensions (e.g., length) of the horn are also directly proportional to the temperature. It is possible to measure the temperature of the horn to determine the dimensions, and thus known the resonant frequency.

A welding apparatus, based on using frequency feedback or temperature to adjust the gap between the anvil and the horn, generally includes a frequency sensor adapted to provide a signal based on the frequency of the horn, and a positioning system for adjusting the gap between the horn and the anvil in a predetermined way based on the signal. The frequency sensor can be selected to determine the frequency by, for example, the voltage delivered by the source of ultrasonic energy, the current drawn by the source of ultrasonic energy, the voltage induced in an inductive sensor positioned near the horn, the change in capacitance of a capacitance sensor positioned near the horn, an optical sensor positioned to observe the horn, and a contact sensor in physical contact with the horn. Any or all of the sensor, positioning system, horn, anvil, and ultrasonic energy source can be supported on a support bracket or other mounting system or systems.

The use of frequency feedback or temperature feedback to compensate for increases in a horn dimension can be used with a rotary anvil, stationary anvil, rotary horn, stationary horn, or any combination thereof. The system can be configured to adjust the distance between the anvil and the horn, or to adjust the force applied to one of the anvil and the horn (usually the horn) to bring the two to the desired distance with the material therebetween.

In use, the materials to be joined would be positioned between the horn and the anvil, energy would be applied to the horn and the horn would be energized, the operating frequency of the horn would be measured, and the distance between the horn and the anvil would be adjusted, based on the measurement. The gap between the horn and the anvil is preferably adjusted to maintain a predetermined gap in the face of changes in the horn size. Alternately or additionally, the gap between the horn and the anvil is preferably adjusted to maintain a predetermined force between the horn and anvil in the face of changes in the horn size.

One useful method to measure the gap between the horn and anvil is by mounting a proximity sensor on the anvil or the horn and measuring the change in gap from a predetermined machine surface. The gap is then adjusted by using an active linear (servo) motor, which moves the horn or the anvil to maintain a fixed gap.

In some designs, it may be desired to use a cooling device, to facilitate control of the temperature of the horn or the anvil or both. Controlling the temperature would also have an effect on the frequency.

Additional details regarding controlling the gap between the anvil and horn by frequency feedback are described in Assignee's co-pending application 60/640,978, entitled “Frequency Based Control of an Ultrasonic Welding System”, having attorney docket number 60272US002, the entire disclosure of which is incorporated by reference herein.

Summarized, a method to monitor the gap using frequency feedback would include receiving a resonant frequency of a vibrating tool (e.g., the horn), and determining a quantity standing in known relation to an approximate change in distance of the gap between the vibrating tool and a fixed reference point, based upon the resonant frequency. This could include calculating the length of the vibrating tool, as a function of the resonant frequency and material characteristics of the vibrating tool. The method could then include adjusting the distance between the vibrating tool and the reference point, so as to substantially maintain a constant gap; this could be done based upon the resonant frequency of the vibrating tool. Monitoring the gap using temperature feedback would be similar, as appropriate.

A system for applying ultrasonic energy to a workpiece, by such a method, would include a horn stack (which includes the horn), a mounting system upon which the horn stack is mounted, a source of energy coupled to the horn stack, an anvil having a surface for supporting the workpiece, and a controller configured to receive a resonant frequency of the horn stack, and to determine a quantity standing in known relation to a change in gap between the horn stack and the anvil. This change in gap could be determined from a table of previously obtained data; values not found on the table can be interpolated or extrapolated from known data. Instead of a controller, the system could have any mechanism for determining a quantity standing in known relation to a change in gap between the horn stack and the anvil. Systems to monitor the gap using temperature feedback would be similar, as appropriate.

Controlling Gap by Deflectable Horn Stop

A third general method for better controlling the gap and the movement between the horn and the anvil during the welding process is provided below. In “fixed gap” applications, the distance between the horn and anvil is generally controlled by a fixed stop, which inhibits movement of the horn closer to the anvil. As described above, during use the horn expands, and the gap between the horn and anvil is reduced to less than an acceptable value. Described above was a method for measuring the gap by monitoring the horn expansion; described below is a method for controlling the gap without monitoring the horn.

The horn is attached to a linear slide assembly to which a force is applied to urge the horn towards the anvil. A fixed stop is used to set the desired gap between the horn and the anvil. The force applied to the slide is generally larger than that required to weld the products. Additionally, the force is sufficient to cause elastic deformation of the stop assembly equal to or greater than the expected expansion of the horn. As this deflection of the stop assembly occurs, the horn moves closer to the anvil.

The stop assembly position is set so that the desired gap is obtained when the horn is cold and the maximum force is applied so that the maximum stop deflection occurs. As the horn expands during operation, the increased length of the horn is determined, for example, as described above using the frequency reduction. As the horn expands, the applied force is reduced which reduces the deflection of the fixed stop by an amount equal to the thermal expansion of the horn. The relationship between deflection distance and force is preferably determined prior to operation; that is, a trial run is made to set the stop location. The results of the trial run can be recorded, for example, in a table, which can be later referenced. Values not found on the table can be interpolated or extrapolated from known data. The gap between the horn and the anvil thus is controlled, and preferably held constant throughout the welding process.

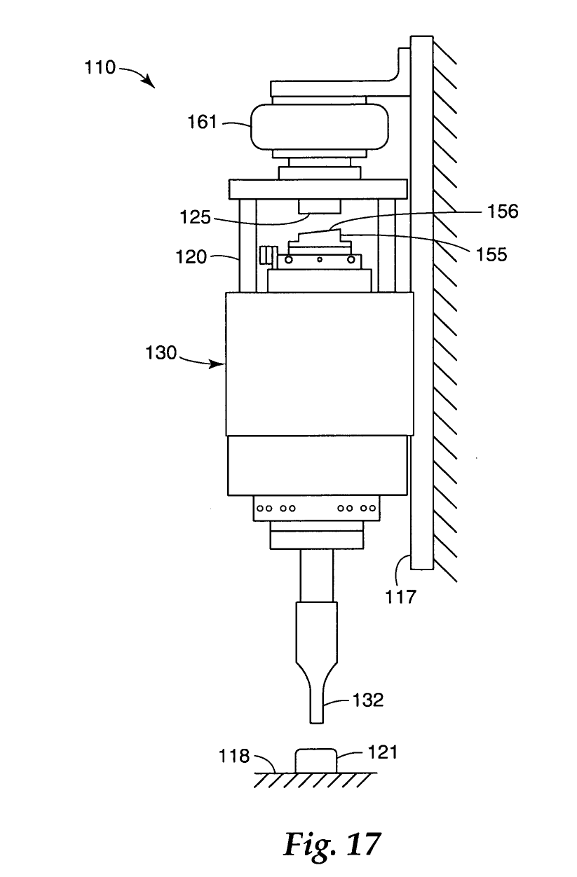

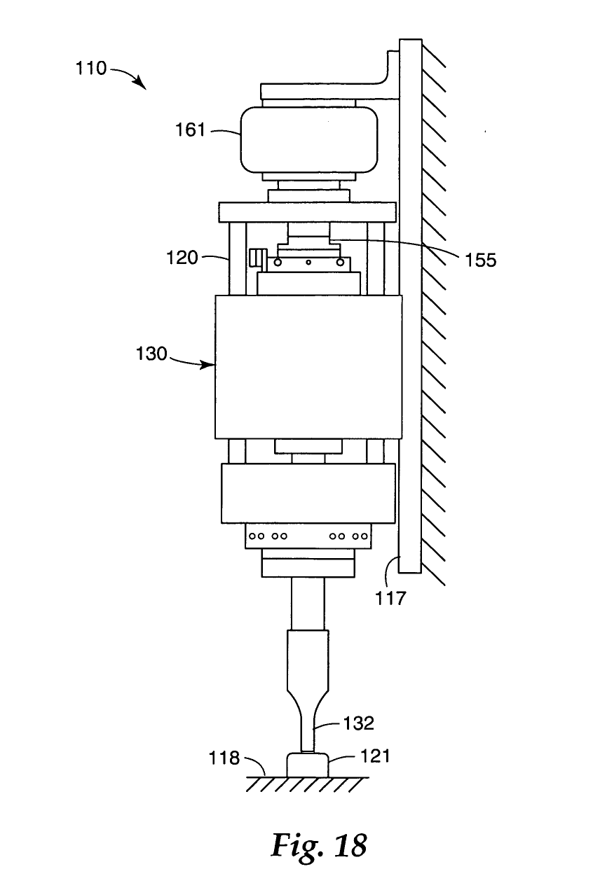

FIGS. 17 and 18 illustrate an example system that uses a flexible fixed stop. FIG. 17 shows the unit with the horn in the retracted position, or moved away from the anvil. FIG. 18 shows the unit with the horn moved to the welding position with the gap between the horn and anvil set. Welding system 110 has a welding system 130 fixed to support surface 117 and an anvil 121 fixed to support surface 118. Welding system 130 includes horn 132, which is supported by horn support 120 and is moveable in relation to surface 117, a fixed stop 155 having support plate 156, which are fixed in relation to surface 117, and an expandable pneumatic bladder 161.

Bladder 161 is used to apply the force to move horn support 120 and horn 132 toward anvil 121. As surface 125 contacts fixed stop 155, support plate 156 deflects slightly under the applied force.

In operation with a titanium horn, it was determined that the temperature will increase from room temperature by a maximum of 50° F. (about 10° C.), which will increase the horn dimension by 0.0010 inch (about 0.025 mm). As a result, the gap between horn 132 and anvil 121 is reduced by 0.0010 inch (about 0.025 mm), if no compensation is made. The deflection of support plate 156 is known to be 0.0010 inch (about 0.025 mm) per 675 pounds force (about 306 kg-force). Therefore, the applied force with a room temperature horn must be at least 1125 pounds (about 510 kg), or 60 psig (about 414 kPa). As the horn operates and increases in length, the applied air pressure is reduced from 60 psig (about 414 kPa) to 30 psig (about 207 kPa) to keep the gap between horn and anvil constant.

A welding apparatus, generally configured to control the distance between the anvil and the horn by utilizing a deformable stop assembly, includes an anvil with a fixed stop, a horn, and a force applicator mounted so as to be able to apply force to press the horn against the fixed stop such that elastic deformation of the fixed stop provides fine control over the gap between the horn and the anvil. The apparatus may include a sensing system to monitor a specific property of the horn and control the force applied to the horn so as to hold the gap between the horn and the anvil at a fixed value despite changes in the specific property. The property monitored could be, for example, temperature, a dimension such as length, or vibration frequency of the horn.

The use of a deformable, yet fixed stop to compensate for the horn dimension increase, due to thermal expansion, can be used with a rotary anvil, stationary anvil, rotary horn, stationary horn, or any combination thereof.

Additional details regarding controlling the gap between the anvil and horn by using a deflectable stop are described in Assignee's co-pending application 60/641,048, entitled “Gap Adjustment for an Ultrasonic Welding System”, having attorney docket number 60273US002, the entire disclosure of which is incorporated by reference herein.

In general, a system for controlling the gap uses a fixed deflectable stop include a mount comprising a translation member and a fixed elastic deformable stop, a horn coupled to a source of ultrasonic energy, the horn being operatively connected to the translation member, an anvil separated from the horn by a gap, and a force applicator to urge the horn toward the anvil. The force applicator also causes a member operatively coupled to the horn to contact and deform the elastic deformable stop by varying degrees, so that the gap between the horn and the anvil remains substantially constant during operation of the system. An alternate system could have a horn separated from an anvil by a mounting system, a source of ultrasonic energy coupled to the horn, and any mechanism for substantially maintaining the separation at a constant length, while the horn experiences thermal expansion.

Such systems generally operate by positioning the horn proximal to the anvil so that a gap is established between the horn and the anvil, applying a force to the horn, so as to urge the horn toward the anvil, positioning the deformable stop at a location, such that application of the urging force causes a member operatively connected to the horn to abut the deformable stop, and to deform the stop, and iteratively adjusting the urging force during operation of the horn, so as to adjust the extent of the deformation of the deformable stop, and to maintain the gap between the horn and the anvil substantially constant.

Controlling Gap by Adjusting Horn Amplitude

The gap between the anvil and horn may also be controlled by adjusting the vibration amplitude of the vibrating tool, which is usually the horn. Such a system generally includes a horn or horn stack held by a mounting system. A power supply is operatively coupled to the horn stack, and configured to supply an alternating current (AC) signal of a given amplitude to the horn in response to a command, and is further configured to output data indicating frequency of the AC signal supplied to the horn. A controller is operatively coupled to the power supply. The controller is configured to receive the frequency data from the power supply, and to command the power supply to deliver an AC signal of a selected amplitude determined by the frequency data. As the amplitude varies, so does the gap between the horn and anvil.

Generally, a method using this underlying theory would include positioning a horn proximal an anvil, so that a gap is established between the horn and the anvil. An alternating current (AC) signal is applied to a converter coupled to the horn, and the AC signal exhibits an amplitude. The amplitude of the AC signal is adjusted during operation of the horn, so as to maintain the gap between the horn and the anvil substantially constant.

Additional details regarding controlling the gap between the anvil and horn by using a deflectable stop are described in Assignee's co-pending application Ser. No. 11/268141, filed Nov. 7, 2005 entitled “Amplitude Adjustment of an Ultrasonic Horn”, having attorney docket number 61397US002, the entire disclosure of which is incorporated by reference herein.

Products

Any of the methods discussed above are suitable for making multi-layered laminated product 10. Laminated composite material 10 has nonwoven tape 12 (in one embodiment two pieces of nonwoven tape 12) welded to a base layer 16 at weld areas W. Base layer 16 can be, for example, an elastic material, such as a laminated elastic material which has at least one layer of elastomeric material. Composite material 10 can also include mechanical attachment portion 18 and finger lift tab 20. Adhesive layer 14 may be present on nonwoven tape 12 adjacent base layer 16.

The laminate bond between nonwoven tape 12 and base layer 16, made with a rotary horn, generally has improved surface softness and increased flexibility over similar products made with a stationary horn. Material 10, when welded with a rotary horn, also generally shows an increase of laminate strength when compared to a product made by a stationary horn at the same line speed. Products having welds made with the rotary horn usually have higher tensile and tear forces. There is a decreased likelihood in having holes or tears in the welded area of material when a rotary horn is used, compared to a stationary horn. These generalizations also typically hold for systems that use a rotary anvil.

Welds made with the rotary process using a patterned anvil or horn are soft to the touch and with a distinct pattern. Similar composite materials made by stationary welding, in comparison, although suitable, are not as soft, and often have a trough in the area of the weld. In addition, a rotary process produces a bond with higher strength and at higher line speed. For example, the tensile strength at 200 meters per minute for the rotary process was generally equivalent to the tensile strength at 50 meters per minute from the stationary horn.

### EXAMPLES

The following non-limiting examples further illustrate multi-layered laminated products made by rotary ultrasonic welding. All parts, percentages, ratios, etc., in the examples are by weight unless otherwise indicated.

Test Methods

The bond strength of the laminates of the invention was tested using the following methods.

Break Tensile Strength

The break tensile strengths of the laminates in the bonded regions were measured according to ASTM D882 with an INSTRON Model 1122 constant rate of extension tensile machine. A sample, 40 mm wide by 70 mm long, was cut from a roll of the welded laminate, the long direction being in the cross direction (CD) of the roll. The sample was mounted in the jaws of the test machine with an initial jaw separation distance of 50 mm. The jaws were then separated at a rate of 500 mm/min until the break (failure) point of the sample was reached. The break point almost always occurred at the ultrasonic bond region of the laminate. The maximum load was recorded in Newtons (N). Ten replicates were tested and averaged together and reported in Table 1 in N/40 mm units.

Trapezoidal Tear Strength

The strength of the ultrasonic bonds was also measured using a trapezoidal tear test using the procedure described in ASTM D5587 with the INSTRON Model 1122. Test samples, 40 mm wide by 70 mm long, were cut from a roll of the laminate, the long direction being in the cross direction (CD) of the roll. Testing guide lines were drawn on each end of the samples starting from the bonded region at one edge and extending at a 30 degree angle to the machine direction of the roll to the other edge. The sample was mounted in the jaws of the test machine with an initial jaw separation distance of 35 mm such that bottom edge of the jaws coincided with the 30 degree guide lines. This resulted in a non-symmetrical buckling of the laminate within the jaws, which causes a stress concentration at the edge of the jaws which then results in a tearing of the laminate along the ultrasonic bonded region of the laminate. The jaws were then separated at a rate of 500 mm/min until the break (failure) point of the sample was reached. The maximum load was recorded in Newtons (N) as the sample tore from one edge of the sample to the other. Ten replicates were tested and averaged together and reported in Table 1 in N/40 mm units.

### Example 1

Nonwoven Fastening Tape 12, available from the 3M Company, St. Paul, Minn., as KD-3613, consisting of a 50 g/m² spunbond polypropylene nonwoven polycoated with a 28 g/m² polypropylene/polyethylene impact copolymer, release coated on the non-polycoated side with a 2 g/m² silicone-acrylate release coating and adhesive coated on the polycoated side with a 33 g/m² hot melt adhesive 14, consisting of 50% KRATON 1119 (SIS block copolymer, Kraton Polymers, Inc. Houston, Tex.) and 50% WINGTACK Plus (solid tackifier, Sartomer, Exton, Pa.).
Fingerlift 20, available from the Amtopp Corp. Livingston, N.J., 40 micron white biaxially oriented polypropylene.
Fastener 18, available from the 3M Company, St. Paul, Minn. as KN-3457, 107 g/m² polypropylene/polyethylene impact copolymer with 3% white pigment, 360 hooks/cm² similar to the Example in U.S. Pat. No. 6,190,594.
Nonwoven/Elastic Laminate 16, was prepared by adhesive laminating a 20 g/m² polypropylene spunbond nonwoven 16 (First Quality Nonwovens Inc., Great Neck, N.Y.) onto each side of a 105 g/m² three-layer coextruded elastic film 22, consisting of a central core layer (94 g/m²) made from a blend of 70% KRATON G1114 (SIS block copolymer, Kraton Polymers, Inc. Houston, Tex.) and 30% 5E57 (polypropylene, Dow Chemical, Midland, Mich.) and a skin layer (6 g/m²) on each side of the core layer made from polypropylene (5E57, Dow Chemical, Midland, Mich.).

The coextruded elastic film was stretched in the cross-direction 5.3 to 1 and, while held in the stretched state, laminated on both sides to nonwoven webs which had been sprayed in a swirl pattern with a 4.5 g/m² adhesive (H2494, Bostik Adhesives, Middleton, Mass.). The laminate was then allowed to relax and wound into a roll.

An apparatus similar to that shown in FIGS. 5-18 was used to laminate and bond the above materials together to form an item as illustrated in FIG. 1. The materials were bonded at a linespeed of 200 meters/minute using a rotary ultrasonic horn and rotary ultrasonic anvil similar to that shown in FIG. 4. The anvil was a steel cylinder having a series of radially arranged pins configured to provide 4 mm wide dot welding patterns similar to that shown in FIG. 4B. The pins consisted of a staggered array of truncated cones having a height of 0.58 mm and an upper land area of 0.5 mm². the center-to-center spacing of the pins was 1.6 mm. The apparatus was run with a fixed gap of 1.5 mils (about 37 micrometers) with the amplitude of the horn set at 100%, 2.1 mils peak-to-peak (53 microns) and a frequency of 20 kilohertz.

The strength of the resulting ultrasonic bond was measured using the tensile and tear tests described above and the results are shown in Table 1 below.

### Example 2

The same materials as in Example 1 were laminated and bonded together using the same rotary ultrasonic welding apparatus as in Example 1, except the linespeed was 60 m/minute.

The strength of the resulting ultrasonic bond was measured using the tensile and tear tests described above and the results are shown in Table 1 below.

### Comparative Example C1

The same materials as described in Example 1 above were laminated and bonded together using a stationary ultrasonic welding apparatus. A rotary anvil and a stationary scan (bar) horn were used. The anvil was a steel cylinder having a series of radially arranged diamond-shaped pins configured to provide 4 mm wide dot welding patterns similar to that shown in FIG. 4A. The pins consisted of an array of truncated pyramids having a height of 0.5 mm and an upper land area of 0.5 mm². The center-to-center spacing of the pins was 1.5 mm. The materials were welded using a line speed of 50 m/minute and an amplitude of 2.1 mils peak-to-peak. A force of 1400N was maintained between the horn and the anvil.

The strength of the resulting ultrasonic bond was measured using the tensile and tear tests described above and the results are shown in Table 1 below. The strength of the ultrasonic bond for Example C1 was equivalent to that of Example 1, but at a much lower line speed. The strength of the ultrasonic bond for Example C1 was much less than in Example 2, which had a similar line speed.

### Example 3

A laminate similar to that shown in FIG. 1 was prepared using the following materials:
Nonwoven Fastening Tape 12, available from the 3M Company, St. Paul, Minn., as KFT-2524, consisting of a 50 g/m² spunbond polypropylene nonwoven polycoated with a 28 g/m² polypropylene/polyethylene impact copolymer, release coated on the non-polycoated side with a 0.9 g/m² epoxy silicone release coating and adhesive coated on the polycoated side with a 33 g/m² hot melt adhesive 14, consisting of 49% KRATON 1107 (SIS block copolymer, Kraton Polymers, Inc. Houston, Tex.) and 46% ESCOREZ 1310 (hydrocarbon solid tackifier, Exxon Mobil Chemicals, Houston, Tex.) and 4% Sylvarez TRA 25 (liquid tackifier, Arizona Chemical Co., Jacksonville, Fla.) and 1.0% IRGANOX 1076 (antioxidant, Ciba Specialty Chemicals, Basel, Switzerland).

Fingerlift 20, available from Treofan GmbH, Raunheim, Germany, 35 micron white biaxially oriented polypropylene (Trespaphan).

Fastener 18, available from the 3M Company, St. Paul, Minn., as KHK-0002, micro-replicated hook material, 105 g/m² polypropylene/polyethylene impact copolymer with 1.5% white pigment, 250 hooks/cm², similar to the example in U.S. Pat. No. 5,845,375.
A nonwoven/elastic laminate was not used.
Two layers of nonwoven material consisting of a first layer of 50 g/m² polypropylene spunbond nonwoven 16 (Pegatex S 1.5 denier, Pegas Nonwovens, Czech Republic) and a second layer of a 22 g/m² polypropylene carded nonwoven 24 (Sawabond 4132, Sandler AG, Germany). The two nonwovens were thermobonded together.

An apparatus similar to that shown in FIGS. 5-18 was used to laminate and bond the above materials together. The materials were bonded at a linespeed of 300 meters/minute using a rotary ultrasonic horn and rotary ultrasonic anvil similar to that shown in FIG. 4. The same anvil as in Example 1 was used. The apparatus was run with a fixed gap of 1.5 mils (about 37 micrometers) with the amplitude of the horn set at 100% (53 microns) and a frequency of 20 kilohertz.

The strength of the resulting ultrasonic bond was measured using the tensile and tear tests described above and the results are shown in Table 1 below.

TABLE 1

| | | Tensile Strength | Tear Strength |
|---|---|---|---|
| Example | Line Speed (m/min) | (N/40 mm) | (N/40 mm) |
| 1 | 200 | 55 | 48 |
| 2 | 60 | 68 | 56 |
| C1 | 50 | 56 | 46 |
| 3 | 300 | 83 | 56 |

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This application is intended to cover any adaptations or variations of the preferred embodiments discussed herein. It should be understood that this invention is not limited to the illustrative embodiments set forth herein.

What is claimed:

1. A method of welding a nonwoven layer to a base layer, the method comprising:
(a) providing an ultrasonic system comprising an anvil and a horn stack comprising a horn, the anvil and horn having a gap therebetween;
(b) placing the nonwoven layer and the base layer together within the gap between the anvil and the horn;
(c) rotating at least one of the horn and the anvil while vibrating the horn with ultrasonic energy to obtain a frequency;
(d) contacting the nonwoven layer and the base layer with the horn and the anvil;
(e) monitoring at least one of the frequency and a temperature of at least one of the horn or the anvil; and
(f) while maintaining the gap between the anvil and the horn based on either the temperature or a change in the frequency, welding the nonwoven layer to the base layer.

2. The method of claim 1, wherein contacting the nonwoven layer and the base layer with the horn and the anvil comprises:
(a) contacting the nonwoven layer with the horn and the base layer with the anvil.

3. The method of claim 1, wherein placing the nonwoven layer and the base layer together within the gap comprises:
(a) including an adhesive layer positioned between the nonwoven layer and the base layer.

4. The method of claim 1, wherein placing the nonwoven layer and the base layer together within the gap comprises:
(a) placing the nonwoven layer and a base layer comprising elastic together within the gap.

5. The method of claim 4, wherein placing the nonwoven layer and the base layer together within the gap comprises:
(a) placing the nonwoven layer and a base layer comprising a first nonwoven surface on an elastic film, the first nonwoven surface positioned between the elastic film and the adhesive layer.

6. The method of claim 5, wherein placing the nonwoven layer and the base layer together within the gap comprises:
(a) placing the nonwoven layer and a base layer further comprising a second nonwoven surface on the elastic film opposite the first nonwoven surface.

7. The method of claim 1, wherein placing the nonwoven layer and the base layer together within the gap comprises:
(a) placing the nonwoven layer, a second nonwoven layer and the base layer within the gap.

8. The method of claim 1, wherein providing an ultrasonic system comprises:
(a) providing a mounting system for supporting a rotatable horn so that it can rotate about a first axis and such that the rotatable horn has only two additional degrees of freedom,
(i) the first additional degree of freedom being translational motion in a direction perpendicular to the first axis, and
(ii) the second additional degree of freedom being rotational motion about a second axis that is both perpendicular to the first axis and the direction of the first additional degree of freedom;
(b) mounting the horn within the mounting system; and
(c) contacting the web with the horn so as to treat the web.

9. The method of claim 8, wherein providing an ultrasonic system comprises providing a mounting system comprising:
(a) a frame having two side plates, each side plate having a bearing surface and having a slot therein;
(b) a pair of support elements each adapted to engage the horn in such a fashion that the horn is free to rotate, wherein each support element comprises:
(i) a slide portion slidably engaging one of the slots; and
(ii) a bearing portion having a curved surface engaging the bearing surface.

10. The method of claim 9, wherein maintaining the gap between the anvil and the horn comprises maintaining the gap between the anvil and the horn constant by providing a mechanism for limiting the maximum amount of motion within the second additional degree of freedom.

11. The method of claim 1, wherein maintaining the gap between the anvil and the horn comprises:
(a) receiving a resonant frequency of the horn, wherein a portion of the horn is fixed a given distance from the anvil by a rigid mounting system; and
(b) determining a quantity standing in known relation to an approximate change in length of the gap, based upon the resonant frequency.

12. The method of claim 11, wherein determining the quantity standing in known relation to the approximate change in length of the gap comprises:
(a) accessing a table to obtain a gap corresponding to the resonant frequency.

13. The method of claim 11, wherein determining the quantity standing in known relation to the approximate change in length of the gap comprises:
(a) accessing a table to obtain first and second quantities corresponding to frequencies straddling the resonant frequency; and
(b) interpolating between the first and second quantities, to arrive at the approximate gap.

14. The method of claim 11, wherein determining the quantity standing in known relation to the approximate change in length of the gap comprises:
(a) calculating a dimension of the horn, as a function of the resonant frequency and material characteristics of the horn.

15. The method of claim 11, wherein maintaining the gap between the anvil and the horn comprises:
(a) adjusting the given distance between the fixed portion of the horn and the anvil, so as to substantially maintain a constant gap.

16. The method of claim 11, wherein maintaining the gap between the anvil and the horn comprises:
(a) adjusting the given distance between the fixed portion of the horn and the anvil, based upon the resonant frequency of the horn.

17. The method of claim 1, wherein maintaining the gap between the anvil and the horn comprises:
(a) applying a force to the horn, so as to urge the horn toward the anvil;
(b) positioning a deformable stop at a location, such that application of the urging force causes a member operatively connected to the horn to abut the deformable stop, and to deform the stop; and
(c) iteratively adjusting the urging force during operation of the horn, so as to adjust the extent of the deformation of the deformable stop, and to maintain the gap between the horn and the anvil substantially constant.

18. The method of claim 17, wherein maintaining the gap between the anvil and the horn comprises:
(a) monitoring the gap between the horn and the anvil, based upon the temperature of the horn.

19. The method of claim 17, wherein maintaining the gap between the anvil and the horn comprises:
(a) monitoring the gap between the horn and the anvil, based upon the resonant frequency of the horn.

20. The method of claim 1, wherein maintaining the gap between the anvil and the horn comprises:
(a) applying an AC signal to a converter coupled to the horn, the AC signal exhibiting an amplitude; and
(b) adjusting the amplitude of the AC signal during operation of the horn, so as to maintain the gap between the horn and the anvil substantially constant.

21. The method of claim 20, wherein maintaining the gap between the anvil and the horn comprises:
(a) monitoring the gap between the horn and the anvil, based upon the temperature of the horn.

22. The method of claim 20, wherein maintaining the gap between the anvil and the horn comprises:
(a) monitoring the gap between the horn and the anvil, based upon the resonant frequency of the horn.

23. The method of claim 20, wherein maintaining the gap between the anvil and the horn comprises:
(a) adjusting the position of the horn, so as to maintain the gap between the horn and the anvil substantially constant.

24. A multi-layered material comprising a first nonwoven layer and a second base layer bonded together by ultrasonic welding, the ultrasonic welding comprising:
(a) providing an anvil and a horn stack comprising a horn, the anvil and horn having a gap therebetween;
(b) rotating at least one of a horn and an anvil while vibrating the horn with ultrasonic energy to obtain a frequency;
(c) monitoring at least one of the frequency and a temperature of at least one of the horn or the anvil; and
(d) maintaining the gap between the anvil and the horn based on either the temperature or a change in the frequency.

25. The multi-layered material according to claim 24, wherein the ultrasonic welding comprises maintaining the gap between the anvil and the horn constant by:
(a) providing a mounting system for supporting a rotatable horn so that it can rotate about a first axis and such that the rotatable horn has only two additional degrees of freedom,
(i) the first additional degree of freedom being translational motion in a direction perpendicular to the first axis, and
(ii) the second additional degree of freedom being rotational motion about a second axis that is both perpendicular to the first axis and the direction of the first additional degree of freedom;
(b) mounting the horn within the mounting system; and
(c) contacting the web with the horn so as to treat the web.

26. The multi-layered material according to claim 25, wherein the ultrasonic welding comprises maintaining the gap between the anvil and the horn constant by providing a mounting system comprising:
(a) a frame having two side plates, each side plate having a bearing surface and having a slot therein;
(b) a pair of support elements each adapted to engage the horn in such a fashion that the horn is free to rotate, wherein each support element comprises:
(i) a slide portion slidably engaging one of the slots; and
(ii) a bearing portion having a curved surface engaging the bearing surface.

27. The multi-layered material according to claim 26, wherein the ultrasonic welding comprises maintaining the gap between the anvil and the horn constant by providing a mechanism for limiting the maximum amount of motion within the second additional degree of freedom.

28. The multi-layered material according to claim 24, wherein the ultrasonic welding comprises maintaining the gap between the anvil and the horn constant by:
(a) receiving a resonant frequency of the horn, wherein a portion of the horn is fixed a given distance from the anvil by a rigid mounting system; and
(b) determining a quantity standing in known relation to an approximate change in length of the gap, based upon the resonant frequency.

29. The multi-layered material according to claim 28, wherein determining the quantity standing in known relation to the approximate change in length of the gap comprises:
(a) accessing a table to obtain a gap corresponding to the resonant frequency.

30. The multi-layered material according to claim 28, wherein determining the quantity standing in known relation to the approximate change in length of the gap comprises:
(a) accessing a table to obtain first and second quantities corresponding to frequencies straddling the resonant frequency; and
(b) interpolating between the first and second quantities, to arrive at the approximate gap.

31. The multi-layered material according to claim 28, wherein determining the quantity standing in known relation to the approximate change in length of the gap comprises:
(a) calculating a dimension of the horn, as a function of the resonant frequency and material characteristics of the horn.

32. The multi-layered material according to claim 28, wherein the ultrasonic welding comprises maintaining the gap between the anvil and the horn constant by:
(a) adjusting the given distance between the fixed portion of the horn and the anvil, so as to substantially maintain a constant gap.

33. The multi-layered material according to claim 28, wherein the ultrasonic welding comprises maintaining the gap between the anvil and the horn constant by:
(a) adjusting the given distance between the fixed portion of the horn and the anvil, based upon the resonant frequency of the horn.

34. The multi-layered material according to claim 24, wherein the ultrasonic welding comprises maintaining the gap between the anvil and the horn constant by:
(a) applying a force to the horn, so as to urge the horn toward the anvil;
(b) positioning a deformable stop at a location, such that application of the urging force causes a member operatively connected to the horn to abut the deformable stop, and to deform the stop; and
(c) iteratively adjusting the urging force during operation of the horn, so as to adjust the extent of the deformation of the deformable stop, and to maintain the gap between the horn and the anvil substantially constant.

35. The multi-layered material according to claim 34, wherein the ultrasonic welding comprises maintaining the gap between the anvil and the horn constant by:
(a) monitoring the gap between the horn and the anvil, based upon the temperature of the horn.

36. The multi-layered material according to claim 34, wherein the ultrasonic welding comprises maintaining the gap between the anvil and the horn constant by:
(a) monitoring the gap between the horn and the anvil, based upon the resonant frequency of the horn.

37. The multi-layered material according to claim 34, wherein the ultrasonic welding comprises maintaining the gap between the anvil and the horn constant by:
(a) determining a quantity standing in known relation to the adjusted urging force, based upon the gap between the horn and the anvil.

38. The multi-layered material according to claim 37, wherein determining the quantity standing in known relation to the adjusted urging force comprises accessing a table to obtain the adjusted force corresponding to the gap.

39. The multi-layered material according to claim 37, wherein determining the quantity standing in known relation to the adjusted urging force comprises accessing a table to obtain a control signal value corresponding to the gap.

40. The multi-layered material according to claim 24, wherein the ultrasonic welding comprises maintaining the gap between the anvil and the horn constant by:
(a) applying an AC signal to a converter coupled to the horn, the AC signal exhibiting an amplitude; and
(b) adjusting the amplitude of the AC signal during operation of the horn, so as to maintain the gap between the horn and the anvil substantially constant.

41. The multi-layered material according to claim 40, wherein the ultrasonic welding comprises maintaining the gap between the anvil and the horn constant by:
(a) monitoring the gap between the horn and the anvil, based upon the temperature of the horn.

42. The multi-layered material according to claim 40, wherein the ultrasonic welding comprises maintaining the gap between the anvil and the horn constant by:
(a) monitoring the gap between the horn and the anvil, based upon the resonant frequency of the horn.

43. The multi-layered material according to claim 40, wherein the ultrasonic welding comprises maintaining the gap between the anvil and the horn constant by:
(a) adjusting the position of the horn, so as to maintain the gap between the horn and the anvil substantially constant.

44. The multi-layered material according to claim 43, wherein the position of the horn is adjusted within a range, and wherein the ultrasonic welding further comprises:
(a) determining whether the horn would have to occupy a position outside of the range, in order to maintain a constant gap between the horn and the anvil; and
(b) in the event of a positive determination, adjusting the amplitude of the AC signal.

45. The multi-layered material according to claim 43, wherein the amplitude of the AC signal may be adjusted within a range, and wherein the ultrasonic welding further comprises:
(a) determining whether the AC signal would have to exhibit an adjusted amplitude outside of the range, in order to maintain a constant gap between the horn and the anvil; and
(b) in the event of a positive determination, adjusting the position of the horn, so as to maintain the gap between the horn and the anvil substantially constant.

46. The multi-layered material of claim 24 further comprising an adhesive layer positioned between the nonwoven layer and the base layer.

47. The multi-layered material of claim 24, wherein the second base layer comprises elastic.

48. The multi-layered material of claim 47, wherein the second base layer comprises a first nonwoven surface on an elastic film, the first nonwoven surface positioned between the elastic film and the adhesive layer.

49. The multi-layered material of claim 48, wherein the second base layer further comprises a second nonwoven surface on the elastic film opposite the first nonwoven surface.

50. The multi-layered material of claim 24 further comprising a second nonwoven layer bonded to the second base layer.
